(19) United States
(12) Patent Application Publication
(10) Pub. No.: US 2009/0149576 A1
(43) Pub. Date: Jun. 11, 2009

(54) ELASTOMERIC MATERIAL USEFUL FOR MAKING INCREASED MODULUS RUBBER

(75) Inventors: Arnold Frances, Glen Allen, VA (US); Daniel Li, Pudong Shanghai (CN)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/327,073

(22) Filed: Dec. 3, 2008

Related U.S. Application Data
(60) Provisional application No. 60/992,441, filed on Dec. 5, 2007.

(51) Int. Cl. C08L 25/00; C08L 25/10; C08K 5/29; C08K 5/09; C08K 3/04; C08L 1/02

(52) U.S. Cl. 524/34; 524/502; 524/540; 524/500; 524/539; 524/195; 524/300; 524/35

(57) ABSTRACT

A solid elastomeric reinforcing material for use in the manufacture of compounded rubber goods that is made from an elastomeric material coagulated from a natural or synthetic latex, a natural or synthetic fibrous filler that has a linear density of at least 0.5 dtex, a tenacity of at least 1.0 gram per dtex, a fiber length between 0.1 and 6 mm and a specific surface area range between 0.1-25 square meters per gram and a modulus enhancing additive.

### BACKGROUND OF THE INVENTION

1. Field of the invention

This invention relates to elastomeric materials used in making compounded rubber.

2. Description of the Related Art

Fibrous fillers have been incorporated into plastics and elastomers for the purpose of providing additional strength to articles fabricated from the polymers, obtaining good surface contact properties for articles such as power transmission belts, and reducing compound cost by serving as low cost fillers. Fibrous fillers have been added to plastics and elastomers by heating the polymers to soften them and thoroughly mixing the polymer and filler on a mill or in an internal mixer. This procedure has inherent drawbacks when fibers are incorporated in certain elastomers. The need for incorporating fibers into elastomers is important for many uses of articles such as, for example, power transmission belts, etc that are fabricated from elastomers. A procedure used on a commercial scale is to mix the solid uncured elastomer with the fibrous filler in a mixer or on a rubber mill. Mixing is typically continued for about 5 to 10 minutes. After that time mixing must be discontinued for a substantial amount of time because the elastomer becomes overheated. If the mixing is continued, the elastomer would degrade and result in substantial lowering of the important properties of the elastomer and/or scorching of the stock. When the mixture of the elastomer and fiber overheats, it must be cooled before mixing is continued. Due to heat build-up as many as six sequences of cooling may be may required.

Moreover, progressive working of the rubber can produce an unusable scorched product before an adequate mix is even possible, especially with aramid fibers in commercial scale mixers when cooling capacity is limited. The incorporation of the fibrous fillers into the elastomer by conventional methods is both energy intensive and expensive due to the long times required by the fabricator to incorporate fiber into the elastomer.

### BRIEF SUMMARY OF THE INVENTION

In one embodiment the subject invention is a solid elastomeric reinforcing material for use in the manufacture of compounded rubber goods, comprising
(a) a elastomeric material coagulated from a natural or synthetic latex.
(b) a natural or synthetic fibrous filler, the fiber having a linear density of at least 0.5 dtex, a tenacity of at least 1.0 gram per dtex, a fiber length between 0.1 and 6 mm and a specific surface area range between 0.1-25 square meters per gram.
(c) a modulus enhancing additive said additive being selected, either
alone or in combination, from the group comprising phenolic, butyl latex, styrene butadiene vinyl pyridine latex, isocyanate, and polybutadiene adducted with maleic anhydride

### DETAILED DESCRIPTION OF THE INVENTION

The addition of short para-aramid fibers and pulp to an elastomer will significantly increase modulus. Kevlar® Engineered Elastomer (EE) is a concentrate of Kevlar® pulp or Kevlar® short fiber in an elastomer and is used to facilitate the incorporation and improve the dispersion of Kevlar® pulp or fiber into an elastomer. Kevlar® is a registered trademark of E.I. du Pont de Nemours and Company, Wilmington, Del. (DuPont). However, there remains a need for higher strength and particularly higher modulus materials that can still be produced economically. In one embodiment the present invention provides for the addition of an adhesive promoting resin during the engineering elastomer (EE) manufacturing process as a modulus enhancing additive. The elastomers used in this invention must be in the form of a latex. Generally, the latex has a solids content of about 25-75% or even about 35-60%. Conventional emulsifying agents and an elastomeric monomer e.g., chloroprene monomer, are mixed with water and other ingredients to form an emulsion and, subsequent to polymerization, a latex. The latex particles consist of aggregates of the elastomer protected by the emulsifying agent, e.g., rosin soaps, which are absorbed on the surface of the particles. Representative elastomer latexes that can be used in the process of this invention include polychloroprene, styrene-butadiene, polybutadiene, nitrile-butadiene rubber, hydrogenated nitrile-butadiene rubber, natural rubber, fluoroelastomers and polyisoprene. Polychloroprene is especially preferred.

Styrene/butadiene elastomer latexes are well known in the art and also can be used in this invention. These elastomer latexes are prepared by polymerizing an emulsion of generally, from 60 to 75 parts by weight butadiene, from 25 to 40 parts by weight styrene, from 1 to 5 parts by weight emulsifying agent, from 0.1 to 1.0 parts by weight polymerization catalyst, from 0.1 to 1.0 parts by weight modifying agent and 100 to 300 parts by weight water, at 40° C. to 60° C.

The polybutadiene elastomers suitable for use herein can be produced by a variety of processes. One such suitable process is free-radical polymerization in emulsion initiated by an active free-radical R formed by the decomposition of a peroxide, persulfate or similar free radical forming reaction.

Poly-1,4-isoprene elastomers suitable for use herein include the natural rubbers (both Hevea and Balata) and synthetic polyisoprene. The synthetic polyisoprenes can be emulsion polymerized in an aqueous system using free-radical initiation. Suitable free-radical initiators are potassium persulfate or a redox system using cumene hydroperoxide-ironpyrophosphate. The molecular weight is controlled by addition of a mercaptan such as dodecyl mercaptan.

The organic fibrous filler incorporated in the elastomer can be a natural or synthetic fiber having a linear density of at least 0.5 dtex, a tenacity of at least 1.0 gram per dtex, a length of about 0.1 to 6 mm or about 0.5-3.0 mm and a specific surface area range of 0.1-25 square meters per gram or 5-15 square meters per gram over even 7-11 square meters per gram. The tenacity of the fibrous filler should be at least 7 gram per dtex or at least 18 gram per dtex. The fillers can be aromatic polyamide, polyolefin, polyareneazole, aliphatic or aromatic polyester, fiberglass, carbon, ceramic, polyacrylonitrile, polyvinyl alcohol, nylon, acrylic, cotton, or cellulose used either singly or in combination. The amount of organic fibrous filler added to the elastomer latexes, substantially all of which is incorporated in the polymer, varies depending on the particular use to be made of the elastomers. Generally, amounts between about 10-100 and preferably 20-50 parts fibrous filler per 100 parts of elastomer in the EE are added.

The modulus enhancing material (MEA) can be added to the EE material. Phenolic resin, polybutadiene latex, styrene butadiene vinyl pyridine latex, polybutadiene adducted with maleic anhydride, blocked isocyanate, amine isocyanate and polyisocyanate are suitable materials. A blocked isocyanate may be used wherein it is “unblocked” in the temperature range of 30-200° C. or 40-160° C. or 40-100° C. The amount of modulus enhancing additive required will depend on the required performance level and on the choice of MEA. Levels between 0.1 to 12.0 parts of MEA per hundred parts of rubber in the EE have been shown to be effective. Both aromatic and aliphatic polyisocyanates are suitable MEA's. Examples of these materials are 2,4-toluene diisocyanate (TDI dimer) and the trimer of isophorene diisocyanate (IPDI trimer). With the addition of MEA it has been found that an increase in modulus of over 30% has been achieved with phenolic resin and even greater increases in modulus were obtained from a butyl latex. Improvements in the order of 2× have also been obtained using water dispersible isocyanates and urethanes. Adding the adhesive during the production of the EE is not only an efficient way to produce this high value product, but it is the preferred way to maximize performance. When the adhesive is added to the elastomeric latex/fiber water slurry, the adhesive is put in close proximity with both the elastomer and the fiber, particularly with the fiber much more concentrated than it would be in a normal compounding operation. Having the fiber concentrated and intimately dispersed with the latex before coagulation occurs maximizes the elastomer to fiber adhesion, which ultimately maximizes the performance in the final compound

In one embodiment, the invention is directed to a compounded rubber that incorporates the inventive elastomeric material wherein the rubber has a stress modulus in the machine direction that is higher than that of an otherwise comparable compounded rubber that is made without the addition of a modulus enhancing additive. Surprisingly, it has been found that if the same quantity of modulus enhancing additive is added during compounding of the compounded rubber rather than first incorporating the additive into the elastomeric material, the compounded rubber does not achieve the level of stress modulus in the machine direction as that achieved in the embodiments of the invention. In fact the compounded rubber of this invention with the enhancing additive has a stress modulus in the machine direction that is about 5% -175% higher than that of an otherwise comparable compounded rubber made without the addition of a modulus enhancing additive or when the same quantity of modulus enhancing additive is added during compounding of the rubber rather than included in the EE that is subsequently compounded.

Generally, the first phase of the compounding process involves mastication or breaking down of the polymer. Natural rubber may be broken down on open roll mills, but it is more common practice to use a high shear mixer such as a Banbury or Shaw mixer. Extruders or roll mills can also be used. Occasionally, a separate pre-mastication step may be used, for example, with synthetic rubbers when the compound contains a blend of polymers. This is followed by master-batching when most of the ingredients are incorporated into the rubber. This ensures a thorough and uniform dispersion of ingredients in the rubber. During the mixing process it is important to keep the temperature as low as possible.

An example of a typical mixing process is as follows and is representative of two-stage mixing of a Kevlar® pulp engineered elastomer into a neoprene type rubber:

### First Stage

1. Add successively, while mixing, half the neoprene rubber, then Kevlar® engineered elastomer, and finally the remaining Neoprene and magnesium oxide
2. Mix effectively for 1-1.5 minutes
3. Add loose fibers (if any)
4. Mix at least 30 seconds
5. Add fillers, plasticizers, antioxidant and other additives
6. Increase mixer speed as needed to achieve the desired temperature and continue mixing until good dispersion of the fiber has been obtained,
7. Sheet off the first stage compound at a temperature not exceeding the temperature range of 105-110 C and allow to cool.

### Second Stage

1. Add successively half the cooled product from the first stage, followed by zinc oxide, curatives and the remainder of the first pass mix.
2. Dump at 100-105 C into a sheeting mill.

The present invention is illustrated below by the following preferred embodiments wherein all parts, proportions, and percentages are by weight unless otherwise indicated.

### EXAMPLES

In the following examples, the amount of fiber was present at either zero parts or 4 parts per hundred parts of rubber (phr) in the compounded rubber. The modulus data shown in Table 2 were measured on samples of compounded rubber.

The compounded rubber was prepared using the following materials: Styrene butadiene rubber type 1502 from ISP Elastomers LP, Port Nechas, Tex.
Natural rubber type SMR CV60 from Akrochem Corp., Akron, Ohio
Carbon black type N-299 from Columbian Chemicals Co. Marietta, Ga.
Sundex oil grade 790 from Sunoco, Philadelphia, Pa.
Light stabilizer Vanwax H Special from R.T. Vanderbilt, Norwalk, Conn.
Antioxidant, Antozite 67P, from R.T. Vanderbilt, Norwalk, Conn.
Antioxidant, Agerite resin D, from R.T. Vanderbilt, Norwalk, Conn.
Stearic acide from Crompton Corp, Greenwich, Conn.
Zinc oxide from Zinc Corp. of America, Monica , Pa.
Sulfur from S.F. Sulfur Corp., Valdosta, Ga.
Cure accelerator, Amax, from R.T. Vanderbilt, Norwalk, Conn.
Secondary accelerator, Vanax DPG, from R.T. Vanderbilt, Norwalk, Conn.
Compounded rubber samples were prepared according to the formulations as per Table 1.

TABLE 1

| | | | Comps. 4 &5 | |
|---|---|---|---|---|
| | | Comps. | Control, EE- | |
| | Comp. 1 | 2 &3 | MEA added @ | Ex. 1-17 |
| | No fiber | Control EE | compounding | MEA in EE |
| Ingredient | (phr) | (phr) | (phr) | (phr) |
| SBR 1502 | 50 | 50 | 50 | 50 |
| SMR CV60 | 50 | 36.6* | 36.6* | 36.6* |
| Carbon Black | 45 | 45 | 45 | 45 |
| Sundex 790 | 9 | 9 | 9 | 9 |
| Vanwax H | 1 | 1 | 1 | 1 |
| Antozite 67P | 2 | 2 | 2 | 2 |
| Agerite D | 1 | 1 | 1 | 1 |
| Steraic Acid | 3 | 3 | 3 | 3 |
| Zinc Oxide | 3 | 3 | 3 | 3 |
| Sulfur | 1.6 | 1.6 | 1.6 | 1.6 |
| Amax | 0.8 | 0.8 | 0.8 | 0.8 |
| Vanax DPG | 0.4 | 0.4 | 0.4 | 0.4 |
| EE | 0 | 17.4* | 17.4* | 17.4* |
| MEA added to | 0 | 0 | As Comps. 4 | 0 |
| compound | | | &5 | |
| MEA from EE | 0 | 0 | 0 | See |
| | | | | Examples |
| | | | | 1-17 |

*The 17.4 phr EE contain 4 phr aramid and 13.4 phr of rubber which when added to the 36.6 phr already in the compound yield 50 phr total of SMR rubber.

The rubber was compounded in a Banbury mixer. A pre-mix was prepared by adding the EE, MEA, if not already incorporated into the EE, and half the quantity of rubber polymers and carbon black followed by mixing for 40 seconds. The remaining half quantity of rubber polymers and carbon black was then added and mixing continued for a further 1 minute and 20 seconds. The ram and throat parts of the mixer were then swept clean followed by addition of Sundex 790, Vanwax H, Antozite 67P, Agerite resin, stearic acid and zinc oxide. Mixing was continued for an additional two minutes keeping the mix temperature below 320° F. The premix was then decanted from the mixer.

The final mix was prepared by adding half the quantity of pre-mix followed by the curative ingredients of Amax, Vanax DPG and sulfur. Finally the other half pre-mix was added, the ram and throat swept clean and mixing continued for 40 seconds maintaining the temperature below 210° F. The finished compounded rubber was then removed from the mixer.

In all of the following examples where the MEA was incorporated into the EE, the MEA was added to the aqueous latex slurry prior to addition of coagulant. The coagulant was a mixture of acetic acid and calcium chloride. Further information on this process is detailed in U.S. Pat. No. 5,205,973.

### Examples 1-4

These examples were formed using Elastobond A-150, a solid phenolic resin, as the modulus enhancing additive which is available from the SI Group, Schenectady, N.Y. The phenolic resin was ground by hand to a powder before use. The additive was present at a range of concentration from 1 to 20 parts per hundred parts rubber (phr) in the EE. The mechanical properties of the finished compounded rubber are shown in Table 2.

### Examples 5-7

These examples were formed using Elastobond A-250, a solid phenolic resin, as the modulus enhancing additive which is available from the SI Group, Schenectady, N.Y. The phenolic resin was ground by hand to a powder before use. The additive was present in a range of concentration from 1 to 10 parts per hundred parts rubber in the EE. The mechanical properties of the finished compounded rubber are presented in Table 2.

### Examples 8-11

These examples were formed using Aqualast BL100, a butyl latex, as the modulus enhancing additive which is available from Lord Corp, Erie Pa. The additive was present in a range of concentration from 1.2 to 12 parts per hundred parts rubber in the EE. The mechanical properties of the finished compounded rubber are presented in Table 2.

### Examples 12-14

These examples were formed using Dispercoll BL XP 2514N, an amine encapsulated aromatic polyisocyanate aqueous dispersion which unblocks between 60-90° C., as the modulus enhancing additive which is available from Bayer Material Science LLC, Pittsburgh, Pa. The additive was present in a range of concentration from 0.1 to 2.5 parts per hundred parts rubber in the EE. The mechanical properties of the finished compounded rubber are presented in Table 2.

### Examples 15-17

These examples were formed using, Bayhydur 302, a water dispersible polyisocyanate, as the modulus enhancing additive which is available from Bayer Materal Science LLC, Pittsburgh, Pa. The additive was present in a range of concentration from 0.1 to 2.5 parts per hundred parts rubber in the EE. The mechanical properties of the finished compounded rubber are presented in Table 2.

### Comparative Example 1

This example was formed using only a 50/50 by weight blend of styrene butadiene rubber and natural rubber elastomers with carbon black and the compounding additives as detailed in Table 1, above. No aramid fiber or modulus enhancing additive (MEA) is present in this example. The mechanical properties of the finished compounded rubber were based on the average of four (4) test samples and are presented in Table 2.

### Comparative Example 2

This example was made from production material comprising of Merge 1 F722 natural rubber EE (23% Kevlar® pulp/77% natural rubber by weight) available from DuPont as the carrier to incorporate the fiber into the final compound. This commercial offering contained no MEA in the formulation. The control formulation was adjusted so that the final compound still contained 50 phr of each styrene butadiene rubber and natural rubber but with 4 phr Kevlar® pulp. The mechanical properties of the finished compounded rubber were based on the average seven (7) test samples and are presented in Table 2.

### Comparative Example 3

This example was formed using a laboratory produced EE with the same composition as 1F722, again without any MEA. The mechanical properties of the finished compounded rubber were based on the average five (5) test samples and are presented in Table 2.

### Comparative Example 4

This example was formed using 1F722 EE with a solid butyl elastomer type Bayer Butyl 301 available from Lanxess Inc, Fairlawn, Ohio as the MEA that is added directly to the compounded rubber. The additive was added to the compounded rubber in an amount equal to it being present at a concentration of 4 parts per hundred parts rubber in the EE. The mechanical properties of the finished compounded rubber are presented in Table 2.

### Comparative Example 5

This example was formed using 1F722 EE with the Elastobond A-150 as the MEA which is added directly to the compounded rubber. The additive was added to the compounded rubber in an amount equal to it being present at a concentration of 10 parts per hundred parts rubber in the EE. The mechanical properties of the finished compounded rubber are presented in Table 2.

The mechanical property test coupons on samples of compounded rubber were prepared in a 150 ton Wabash platen press by pressing and curing sufficient rubber to make slabs having dimensions of 4″×6″×0.078″ thick (102 mm×152 mm×2 mm). The rubber was cured at 160° C. for 15 minutes under a pressure of 130 tons.

Compounded rubber modulus and elongation at break values were determined according to ASTM D412-92 using a United Testing Systems mechanical test machine model E-VI. The modulus results are presented as modulus at various percentages of elongation. For example, M10 is the value for the modulus at 10% elongation. The elongation at break results are shown in the column labeled EB.

TABLE 2

| | MEA | | | | | |
|---|---|---|---|---|---|---|
| | CONCEN- | | | | | |
| | TRATION | M10 | M25 | M50 | M100 | EB |
| Example | (PHR in EE) | MPa | MPa | MPa | MPa | MPa |
| Comp 1 No | | 0.47 | 0.73 | 1.07 | 1.56 | 20.9 |
| Fiber | | | | | | |
| Comp 2 1F722 | | 0.90 | 1.64 | 2.87 | 4.74 | 19.4 |
| Comp 3 Lab | | 1.01 | 2.03 | 3.94 | 5.24 | 17.8 |
| Control | | | | | | |
| Comp 4 | 4* | 0.85 | 1.56 | 3.06 | 4.66 | 19.5 |
| 1F722/BL 100 | | | | | | |
| Comp 5 | 10* | 0.97 | 2 | 3.98 | 5.21 | 19.6 |
| 1F722/A-150 | | | | | | |
| Ex 1 | 1 | 0.83 | 1.79 | 3.39 | 4.7 | 16.1 |
| Elastobond A- | | | | | | |
| 150 | | | | | | |
| Ex 2 | 3.3 | 0.98 | 2.24 | 4.8 | 5.57 | 18.2 |
| Elastobond A- | | | | | | |
| 150 | | | | | | |
| Ex 3 | 10 | 1.20 | 2.46 | 5.17 | 5.71 | 16.9 |
| Elastobond A- | | | | | | |
| 150 | | | | | | |
| Ex4 | 20 | 1.17 | 1.92 | 3.81 | 5.43 | 16.75 |
| Elastobond A- | | | | | | |
| 150 | | | | | | |
| Ex 5 | 1 | 0.89 | 2.03 | 4.25 | 5.12 | 15.1 |
| Elastobond A- | | | | | | |
| 250 | | | | | | |
| Ex 6 | 3.3 | 0.99 | 2.49 | 4.81 | 5.46 | 17.4 |
| Elastobond A- | | | | | | |
| 250 | | | | | | |
| Ex 7 | 10 | 1.07 | 2.46 | 5.03 | 5.61 | 17.5 |
| Elastobond A- | | | | | | |
| 250 | | | | | | |
| Ex 8 | 1.2 | 0.92 | 1.73 | 3.79 | 5.74 | 18.4 |
| Agualast BL | | | | | | |
| 100 | | | | | | |
| Ex 9 | 4 | 1.40 | 3.01 | 5.63 | 6.10 | 19.0 |
| Agualast BL | | | | | | |
| 100 | | | | | | |
| Ex 10 | 8 | 1.26 | 3.14 | 6.55 | 6.51 | 18.6 |
| Agualast BL | | | | | | |
| 100 | | | | | | |
| Ex 11 | 12 | 1.29 | 2.99 | 5.65 | 6.14 | 18.6 |
| Agualast BL | | | | | | |
| 100 | | | | | | |
| Ex 12 | 0.1 | 0.82 | 1.67 | 4.13 | 5.57 | 19.5 |
| DISP blocked | | | | | | |
| iso | | | | | | |
| Ex 13 | 0.5 | 1.88 | 4.74 | 6.27 | 6.43 | 19.2 |
| DISP blocked | | | | | | |
| iso | | | | | | |
| Ex 14 | 2.5 | 1.21 | 3.35 | 5.57 | 5.91 | 18.6 |
| DISP blocked | | | | | | |
| iso | | | | | | |
| Ex 15 | 0.1 | 1.42 | 3.08 | 5.2 | 5.86 | 17.85 |
| BAY amine iso | | | | | | |
| Ex 16 | 0.5 | 1.29 | 3.64 | 5.87 | 6.16 | 19.38 |
| BAY amine iso | | | | | | |
| Ex 17 | 2.5 | 1.41 | 3.6 | 5.94 | 6.11 | 19.54 |
| BAY amine iso | | | | | | |

*This equivalent amount was added during the compounding, control EE was used.

The inventive formulation can be advantageously used in many applications, such as in power transmissions (v-belts and timing belts), hoses, seals, diaphragms, conveyor belts, tires, wheels and protective clothing.

What is claimed is:

1. A solid elastomeric reinforcing material for use in the manufacture of compounded rubber goods, comprising
(a) a elastomeric material coagulated from a natural or synthetic latex.
(b) a natural or synthetic fibrous filler, the fiber having a linear density of at least 0.5 dtex, a tenacity of at least 1.0 gram per dtex, a fiber length between 0.1 and 6 mm and a specific surface area range between 0.1-25 square meters per gram.
(c) a modulus enhancing additive said additive being selected, either alone or in combination, from the group comprising phenolic, butyl latex, styrene butadiene vinyl pyridine latex, isocyanate, and polybutadiene adducted with maleic anhydride

2. The elastomeric reinforcing material of claim 1, comprising
(a) 10-100 parts by weight synthetic fibrous filler per 100 parts of elastomeric material
(b) 0.1-20 parts by weight modulus enhancing additive per 100 parts of elastomeric material

3. The elastomeric reinforcing material of claim 1, in which the fibrous filler has a tenacity of at least 18 gram per dtex.

4. The elastomeric reinforcing material of claim 1, wherein the isocyanate additive is selected either alone or in combination from the group comprising aromatic isocyanate, aliphatic isocyanate, blocked isocyanate, aromatic polyisocyanate and aliphatic polyisocyanate.

5. The elastomeric reinforcing material of claim 1, wherein the fibrous filler is selected, either alone or in combination, from the group comprising aromatic polyamide, polyolefin, polyareneazole, polyester, fiberglass, carbon, ceramic, polyacrylonitrile, polyvinyl alcohol, nylon, acrylic, cotton, cellulose.

6. The blocked isocyanate of claim 4, wherein the blocked isocyanate is “unblocked” in the temperature range 30-200° C.

7. The blocked isocyanate of claim 6, wherein the blocked isocyanate is “unblocked” in the temperature range 40-160° C.

8. The blocked isocyanate of claim 7, wherein the blocked isocyanate is “unblocked” in the temperature range 40-100° C.

9. A compounded rubber incorporating the elastomeric reinforcing material of claim 1, said rubber having a stress modulus in the machine direction higher than that of a comparative compounded rubber made without the addition of a modulus enhancing additive.

10. A compounded rubber incorporating the elastomeric reinforcing material of claim 1, said rubber having a stress modulus in the machine direction higher than that of a comparative compounded rubber in which the same quantity of modulus enhancing additive is added during compounding of the rubber rather than via the elastomeric material.

11. The compounded rubber of claim 9, in which the said rubber has a stress modulus in the machine direction equal to or greater than 5% higher than that of a comparative compounded rubber made without the addition of a modulus enhancing additive.

12. The compounded rubber of claim 10, in which the said rubber has a stress modulus in the machine direction equal to or greater than 5% higher than that of a comparative compounded rubber in which the same quantity of modulus enhancing additive is added during compounding of the rubber rather than via the elastomeric material.

13. The compounded rubber of claim 11, in which the said rubber has a stress modulus in the machine direction between 30% -200% higher than that of a comparative compounded rubber made without the addition of a modulus enhancing additive.

14. The compounded rubber of claim 12, in which the said rubber has a stress modulus in the machine direction between 30% -100% higher than that of a comparative compounded rubber in which the same quantity of modulus enhancing additive is added during compounding of the rubber rather than via the elastomeric material.
